(19) United States
(12) Patent Application Publication
(10) Pub. No.: US 2007/0100938 A1
(43) Pub. Date: May 3, 2007

(54) Participant-centered orchestration/timing of presentations in collaborative environments

(76) Inventors: Elizabeth V. Bagley, Cedar Park, TX (US); Pamela Ann Nesbitt, Tampa, FL (US); Amy Delphine Travis, Arlington, MA (US); Lorin Evan Ullmann, Austin, TX (US)

Correspondence Address: IBM CORP (YA);C/O YEE & ASSOCIATES PC, P.O. BOX 802333, DALLAS, TX, 75380, US

(21) Appl. No.: 11/260,580

(22) Filed: Oct. 27, 2005

(51) Int. Cl. G06F 15/16

(52) U.S. Cl. 709/204

(57) ABSTRACT

A method, system, and computer program product for providing participant-centered orchestration/timing of presentations in collaborative environments. With the mechanism of the present invention, participants in an online collaboration environment are allowed to control the real-time presentation of collaboration materials. The mechanism of the present invention polls the participants in the online presentation. When the polling feedback from the participants is received, the polling feedback from each participant is aggregated to form a collective participant response. The pace and/or content of the presentation is then dynamically modified based on the collective participant response. The dynamically modified presentation is then provided to the participants.

### BACKGROUND OF THE INVENTION

1. Field of the Invention

The present invention relates generally to an improved data processing system, and in particular, to a method for providing participant-centered orchestration/timing of presentations in online collaborative environments.

2. Description of the Related Art

Widespread use of computers and the interconnectivity provided through networks allows for different users to collaborate or work with each other in different locations. Collaborating users may be as close as in an office down the hall or on another floor, or as far away as in another city or country. Regardless of the distance, users are able to communicate with each other and collaborate on different projects. For instance, users can communicate with each other through email and instant messages over networks, such as wide-area networks and the Internet. In addition to email and instant messaging, users may use online collaboration tools to conduct presentations and e-meetings, wherein participants may converse with each other in real-time.

In a face-to-face presentation or meeting, participants may indirectly communicate how well they comprehend the content of the presentation via their body language and facial expressions. A presenter may use this indirect feedback from participants to modify the speed of the presentation or the content of the presentation to match the needs of the group of participants. However, in an online collaborative environment, there is no face-to-face contact between the participant and others attending an e-meeting. Consequently, the presenter in the online collaboration may not know that the pace or content of the presentation should be modified in order to meet the needs of the participants. The presenter must still determine the speed of the presentation and the content to be shown to the participants. In addition, due to geographic and language barriers, verbal communication may not be adequate to convey the presentation material in a manner understandable by all of the participants. Some participants having difficulty following the material will not notify the presenter, as interrupting a speaker is considered impolite in some cultures. As comprehension of the material being presented is the collaboration goal, written communication between the presenter and participants may be necessary to obtain feedback from the participants in order for the presenter to be able to address the needs of the collaboration participants.

Therefore, it would be advantageous to have an improved mechanism for allowing participants to control the real-time presentation of materials in an online collaboration environment. It would further be advantageous to have a mechanism for adapting the polling schedule of the participants based on whether the participant is focused on the current presentation material.

### SUMMARY OF THE INVENTION

The present invention provides a method, system, and computer program product for providing participant-centered orchestration/timing of presentations in collaborative environments. With the mechanism of the present invention, participants in an online collaboration environment are allowed to dynamically control the real-time presentation of collaboration materials. The mechanism of the present invention polls the participants in the online presentation. When the polling feedback from the participants is received, the polling feedback from each participant is aggregated to form a collective participant response. The pace and/or content of the presentation is then modified based on the collective participant response. The modified presentation is then provided to the participants.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system in accordance with an illustrative embodiment of the present invention;

FIG. 3 is a block diagram illustrating the relationship of software components operating within a computer system in accordance with an illustrative embodiment of the present invention;

FIG. 4 is an exemplary block diagram of the presentation orchestration/timing system in accordance with an illustrative embodiment of the present invention;

FIG. 5 is a flowchart of a process for using feedback from participants in an online collaboration to control the presentation in accordance with an illustrative embodiment of the present invention;

FIG. 6 is a flowchart of a process for adapting the polling schedule in an online collaboration by tracking participant focus in accordance with an illustrative embodiment of the present invention;

FIG. 7 is a flowchart of a process for presenting certain participants with alternate presentation material and using the feedback from those participants to improve the presentation for other participants in accordance with an illustrative embodiment of the present invention; and

FIG. 8 is a flowchart of a process for using participant feedback for auditing in accordance with an illustrative embodiment of the present invention.

### DETAILED DESCRIPTION OF THE PREFERRED EMBODIMENT

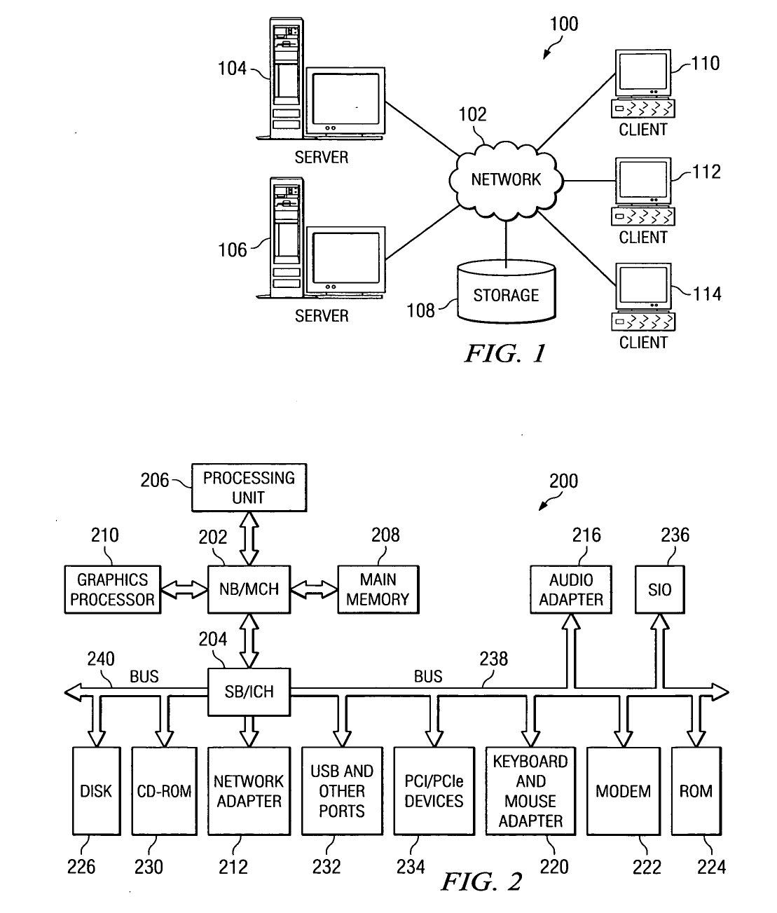

FIGS. 1-2 are provided as exemplary diagrams of data processing environments in which embodiments of the present invention may be implemented. It should be appreciated that FIGS. 1-2 are only exemplary-and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Embodiments of the present invention provide a method, system, and computer program product for improving audience participation in an online collaboration environment. Rather than having the presenter control the pace and content of an online meeting, the mechanism of the present invention allows meeting participants to collectively control the real-time presentation of slides or other presentation materials in the meeting. The mechanism of the present invention solicits opinions or votes (as well as indicia of participant inattention) regarding the presentation from meeting participants that may be time-based or context-based. This data may be obtained using existing polling tools and/or historical data. The mechanism of the presentation aggregates the feedback from each polled participant and determines, based on the collective participant responses, which material should be presented in the meeting and/or the pacing of the presentation for the group.

In one embodiment of the present invention, the mechanism of the present invention uses the participant feedback during the presentation to determine how the presenter should pace the presenter's delivery of the material. As a result, the participants, as a group, may dynamically control the pace of the presentation. For example, the presenter may poll the participants regarding the pace of the presentation. Upon receiving the polling feedback, the presenter adapts the presentation delivery to match the needs of the participant group, such as by speeding up or slowing down. Additionally, previous feedback from the collective group of participants may also be used to predict the speed at which the presenter should deliver the next slide in the presentation.

In another embodiment of the present invention, the collective feedback from the participants may be used to determine which presentation material is of interest to the participants. For example, previously analyzed data may be used prior to the meeting to determine which components of the presentation would be of most interest to the group as a collective. In this manner, a participant group may collectively identify which slides will be covered in the presentation prior to the meeting. In addition, as the meeting progresses, polling may be used to continually adjust the remaining content of the meeting to be presented. Thus, as the meeting progresses, participants may indicate their preference as to what content they would like to hear, which slides should be presented, and in what order, and the remainder of the presentation is altered accordingly.

The mechanism of the present invention may also use the collective feedback from participants to generate audit records for the meeting. Audit records from a prior meeting allow a presenter to predict the appropriate pacing and content with which to conduct future meetings. Audit records may also be used to identify whether the meeting meets quality compliance standards, such as an ISO standard or diversity training guidelines.

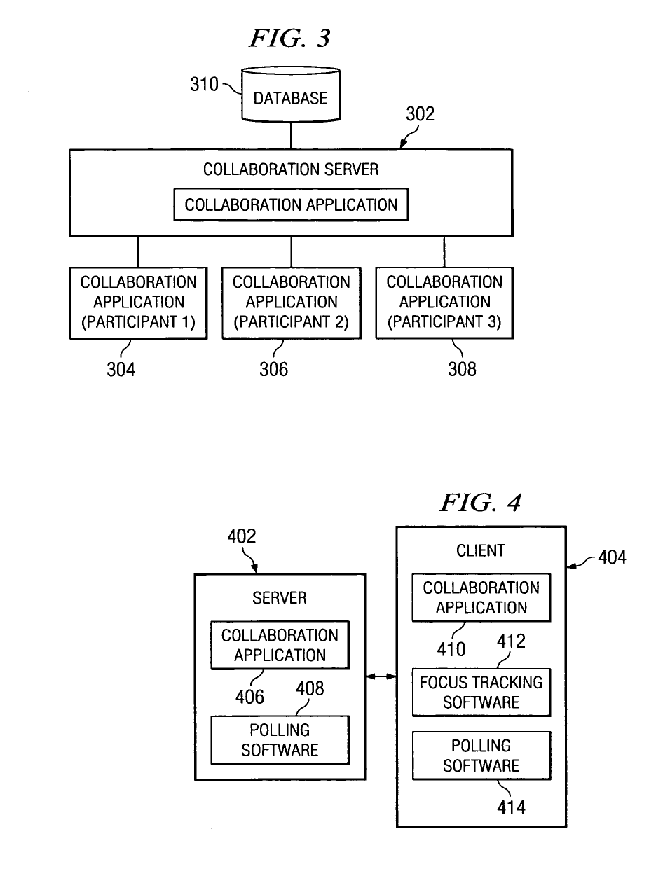

With reference now to FIG. 3, an exemplary block diagram illustrating how an online meeting may be hosted on a collaboration server according to an illustrative embodiment of the present invention is shown. Collaboration server 302 may permit one or more clients to log in to a meeting. Collaboration server 302 may support packet distribution of voice and video from one or more clients over network connections with each client. Collaboration server 302 may be implemented in a server such as server 104 or 106 in FIG. 1.

In this illustrative example, three participants are shown to have joined the meeting through client collaboration applications 304-308. Each client collaboration application may be applications operating on distinct computers, such as, for example, clients 110-114 in FIG. 1. One of the client collaboration applications may be co-resident on conference server 302, such that the collaboration server may operate a collaboration host application and a collaboration client application.

Collaboration server 302 may access database 310. Database 310 may store information concerning participants, which may be looked up with reference to a login identifier of each participant. Database 310 may be implemented in, for example, storage unit 108 in FIG. 1.

FIG. 4 is an exemplary block diagram of the presentation orchestration/timing system in accordance with an illustrative embodiment of the present invention. Collaboration server 402 in FIG. 4 is an example of a server, such as servers 104-106 in FIG. 1 and server 302 in FIG. 3. Client 404 is an example of a client device, such as clients 110-114 in FIG. 1.

In this illustrative example, collaboration server 402 comprises collaboration application 406 and polling software 408. Client 404 comprises collaboration application 410, participant focus tracking software 412, and polling software 414. Collaboration application 410 is an example collaboration software program, such as collaboration applications 304-308 in FIG. 3. Collaboration application 410 allows a participant to login to the online meeting hosted by collaboration server 402. Audio and video of the meeting is then provided to client 404, which is displayed using collaboration application 410.

Polling software 408 and 414 may comprise conventional polling or voting tools. Polling software 408 and 414 may be used to determine how the presenter should conduct the meeting. The presenter on collaboration server 402 may use polling software 408 to poll the participants to determine how the presenter should adjust the presentation for the participants' benefit. For instance, the presenter may poll the participants by asking the participants yes or no questions. An example quick poll may ask the participant, “Are you comprehending the material so far?” The participant may use polling software 414 to receive the poll and provide a response. The participant may indicate that the participant indeed understands the material, such as by selecting an icon of a yes-nodding head. The responses to the polling allows the presenter to determine if the participants would like the presentation material to be presented faster, slower, whether a particular slide should be shown, etc. Polling software 408 may also generate canned instant message questions on the presentation topics to direct a participant's attention back to the meeting. For example, polling software 408 may send canned message questions, such as “What do you think?” and “How is the presentation going so far?” These canned messages may also be sent to the participant's instant messaging window on client 404, since the participant who strays from the presentation is likely to stray to the instant messaging window from the presentation.

Polling software 408 may also be used to obtain voting responses from participants, wherein each participant expresses through the vote support or preference for a certain item. Simple pacing tools may also be used as a form of polling software. For example, the pacing tools may provide a slide bar that allows a participant to move back or forward from the current slide shown in the presentation. If the participant's uses the slide bar to move back or forward from the current slide, this action may indicate that the presentation pace should be increased or decreased, and the presenter may adjust the presentation pace accordingly.

When a participant provides feedback to the presenter, collaboration application 406 may assign a weight to the participant's response. Responses from certain designated participants may carry more weight than others, and thus their responses will affect the collective feedback used when setting the pace of the presentation. For example, a participant that is a customer or a key decision maker may be assigned a higher weight than the other participants. Likewise, a participant's age, gender, and experience may also affect the weight of the participant's response. Regardless of the criteria used to assign weights to the responses, the presenter may use these weights to give priority to the polling responses of particular participants in the meeting.

Focus tracking software 412 may be used to identify the page, slide, or application currently being viewed by the participant. Focus tracking software 412 tracks the participant's actions to determine which page or slide the participant is viewing. The tracking information obtained from focus tracking software 412 allows the presenter to know that the participant is keeping pace with the presentation, or whether the participant is lagging behind or skipping ahead. Focus tracking software 412 also allows the presenter to track the participant's usage of other applications running on the client machine, and thereby determine if the participant's focus has strayed from the presentation. The tracking information may be used by the presenter to determine when the presenter should poll the participant. Thus, focus tracking software 412 allows the presenter to adapt the polling schedule based on the tracking information obtained. The presenter may poll participants in order to keep the participants engaged in the presentation.

In addition, retinal scanners may be used to determine which material in the presentation most captured the participant's favorite attention. These retinal scanners may be conventional scanners known in the art. In one embodiment, focus tracking software 412 may configured to receive input from a retinal scanner connected to client device 404. The retinal scanner may monitor the participant's eyes to determine how long the participant focused on each slide, and thus which slides received the most attention from the participant. The retinal scanner may also determine if the participants eyes are in focus on a particular area of the slide. Focus tracking software 412 may obtain this information from the retinal scanner and generate ratings for each slide in the presentation. These ratings for the slides may be compared against each other to generate a ratings scale that shows each rating in relation to the others.

Certain participants in the meeting may also be identified and polled to obtain advanced feedback to improve the presentation for other participants. These participants may be selected to receive slightly different presentation materials from the rest of the participants. These participants may be selected based on if the participant already understands the material being presented. For example, if a participant is identified as understanding the material, the participant may be given a different version of a slide that is presented to the other participants. The different slide may show a chart in a different form than the original slide shown to the other participants. The participant may be polled to determine whether the participant thinks the different version of the slide is better or worse than the original version. This polling may be performed similar to an eye exam, such as asking the participant whether the different slide is “better or worse” or whether slide “one or two” conveys the material better.

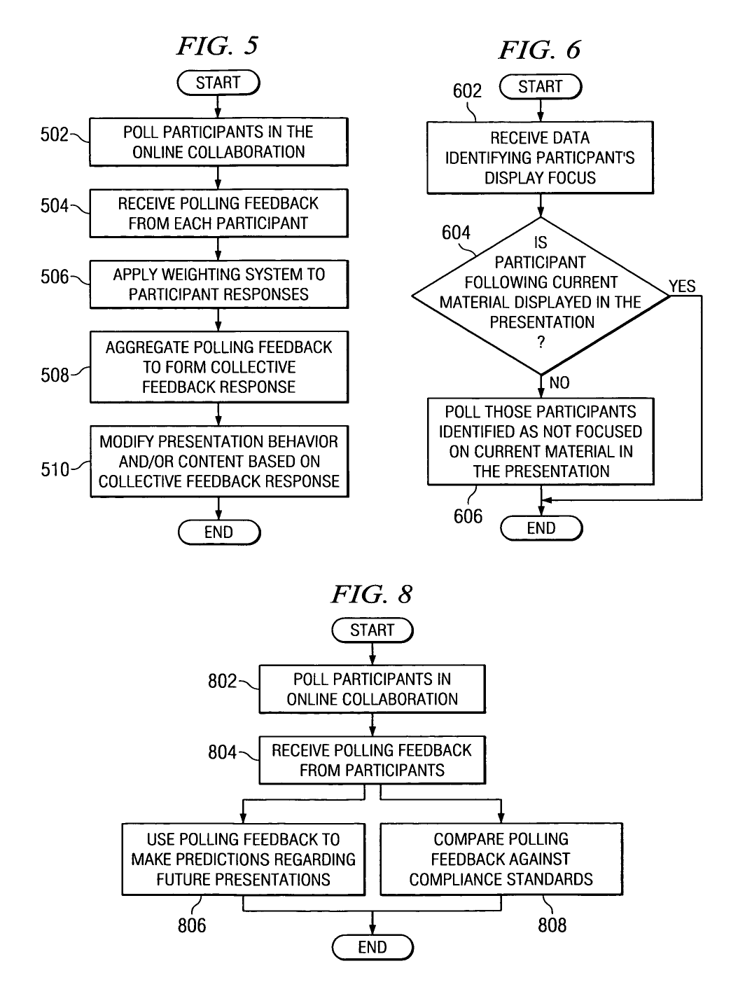

FIG. 5 is a flowchart of a process for using feedback from participants in an online collaboration to control the presentation in accordance with an illustrative embodiment of the present invention. The process described in FIG. 5 may be implemented in a data processing system, such as data processing system 200 in FIG. 2.

The process begins by polling the participants in the online collaboration (step 502). The participants may be polled using any polling software program that presents questions and other information to the meeting audience. The polling program is used to prompt the participants to generate a response to the questions. When a polling response is received from each participant (step 504), the mechanism of the present invention may optionally apply a weighting system to the responses from the participants (step 506). With a weighting system, rather than having each participant's response count the same as the next participant's, a weight value may be applied to each participant's polling response. Responses from participants with higher weight values will carry more weight and thus have higher priority than the responses from participants with lower weight values.

The mechanism of the present invention then aggregates all of the polling results to form a collective participant response (step 508). The mechanism of the present invention may modify the behavior and/or the content of the presentation based on the collective participant response (step 510). For example, the behavior of the presentation may be modified by altering the pace of the presentation. The content of the presentation may be modified to show only the material that the participants wanted to be discussed in the collaboration, as well as to show only the material that the presenter believes the participants group can comprehend based on the collective participant response.

FIG. 6 is a flowchart of a process for adapting the polling schedule in an online collaboration by tracking participant focus in accordance with an illustrative embodiment of the present invention. The process described in FIG. 6 may be implemented in a data processing system, such as data processing system 200 in FIG. 2.

The process begins with receiving data from the client data processing system that identifies the focus of the participant's computer display (step 602). The display focus may comprise the current slide or other presentation material displayed on the participant's computer screen, as well as any application having keyboard focus on the participant's computer display. The client data processing system may perform the identification at the request of the collaboration server, or perform the identification on a periodic schedule and provide the results to the collaboration server.

Based on the focus data received, a determination is made as to whether the participant is following the presentation (step 604). A participant is determined not to be following the presentation if another application has the focus on the participant's computer display or if the participant is viewing a different slide in the presentation than the one currently being displayed to the group. If the participant is determined to be following the presentation, the process is terminated thereafter.

If the participant is determined not to be following the presentation, the polling software on the collaboration server may immediately poll the participant or participants that are not following the presentation (step 606). Immediately polling those participants identified as not engaged in the presentation allows the presenter to change the existing polling schedule in order to bring the participants back into the collaboration. This polling process may also comprise sending pre-canned instant message questions to the identified participants.

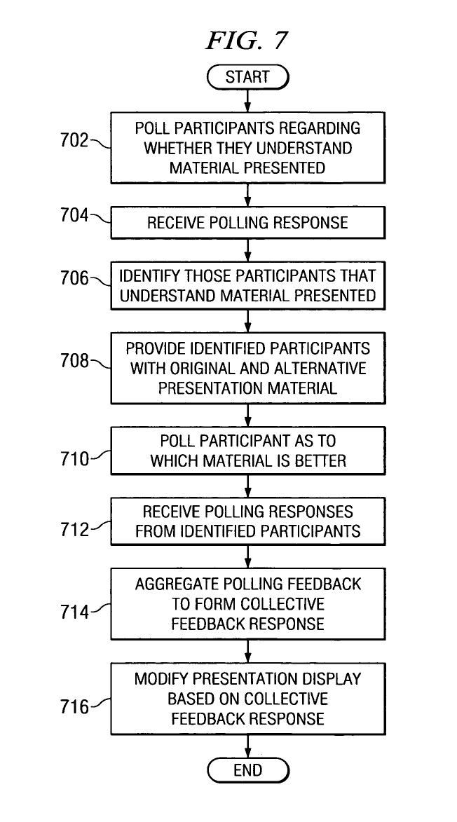

FIG. 7 is a flowchart of a process for presenting certain participants with alternate presentation material and using the feedback from those participants to improve the presentation for other participants in accordance with an illustrative embodiment of the present invention. The process described in FIG. 7 may be implemented in a data processing system, such as data processing system 200 in FIG. 2.

The process begins with polling the participants in the online collaboration as to whether the participants understand the material being presented (step 702). When a response is received from each participant (step 704), the mechanism of the present invention identifies those participants that have responded as having an understanding of the material (step 706). The mechanism of the present invention then provides the identified participants with alternative material in the presentation (step 708). For example, in addition to the slides that are displayed to all participants, an identified participant may be also shown alternative slides. The identified participant is then polled as to which material presented (e.g., the original or the alternative slide) is better (step 710). When poll responses are received from the identified participant (step 712), the mechanism of the present invention aggregates all of the polling results to form a collective participant response (step 714). The mechanism of the present invention may then modify the presentation to display the material based on the collective participant response (step 716). In this manner, the identified participants may be polled in order to obtain advanced feedback to improve the presentation for other participants.

FIG. 8 is a flowchart of a process for using participant feedback for auditing in accordance with an illustrative embodiment of the present invention. The process described in FIG. 8 may be implemented in a data processing system, such as data processing system 200 in FIG. 2.

The process begins with polling the participants in the online collaboration (step 802). When the polling feedback is received from the participants (step 804), the mechanism of the present invention may use the feedback to make predictions regarding presentation pace and content for future presentations (step 806). The mechanism of the present invention may also compare the participant feedback against compliance standards, such as ISO or diversity training, in order to determine whether the presentation meets the compliance criteria (step 808).

Thus, the mechanism of the present invention allows meeting participants to collectively control the real-time presentation of slides or other presentation materials in the meeting. Upon gathering data from each meeting participant regarding the speed and the content of the presentation, the mechanism of the presentation aggregates the feedback from each polled participant and adapts the presentation based on the collective participant responses of the participants.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for allowing participants in an online collaboration environment to control real-time presentation of collaboration materials, comprising:
polling participants of an online collaboration for polling feedback relevant to a real-time presentation;
responsive to receiving polling feedback from the participants, aggregating the polling feedback to form a collective participant response;
dynamically modifying the presentation based on the collective participant response to form a dynamically modified presentation; and
providing the dynamically modified presentation to the participants.

2. The computer implemented method of claim 1, wherein polling participants of an online collaboration further comprises:
tracking participant focus on a participant's computer display; and
determining if the participant focus is on the presentation material currently displayed in the online collaboration.

3. The computer implemented method of claim 2, wherein dynamically modifying the presentation further comprises dynamically modifying a participant polling schedule in response to determining that the participant focus is not on the presentation material currently displayed in the online collaboration.

4. The computer implemented method of claim 1, further comprising:
generating an audit record for the online collaboration, wherein the audit record is used to at least one of predict the pace or content with which to conduct future presentations or determine whether the online collaboration meets quality compliance standards.

5. The computer implemented method of claim 1, further comprising:
assigning a weight to each participant's polling feedback, wherein polling feedback having a higher weight is given priority over polling feedback having a lower weight.

6. The computer implemented method of claim 1, further comprising:
using the polling feedback to identify participants who understand material being presented; and
providing the identified participants with original presentation material and alternative presentation material;
wherein the content of the presentation is dynamically modified to include the alternative presentation material if the identified participants indicate that the alternative presentation material is better than the original presentation material.

7. The computer implemented method of claim 1, wherein dynamically modifying the presentation further comprises dynamically modifying at least one of a pace or content of the presentation.

8. The computer implemented method of claim 7, wherein dynamically modifying the pace of the presentation comprises one of slowing down or speeding up the presentation delivery.

9. The computer implemented method of claim 7, wherein dynamically modifying the content of the presentation comprises altering slides to be displayed in the presentation.

10. The computer implemented method of claim 1, wherein the polling feedback indicates a speed of presentation delivery meeting the needs of the participants.

11. The computer implemented method of claim 1, wherein the polling feedback indicates presentation material of interest to the participants.

12. The computer implemented method of claim 3, wherein dynamically modifying the polling schedule further comprises immediately polling a participant to redirect the participant focus to the presentation material currently displayed in the online collaboration.

13. The computer implemented method of claim 12, wherein immediately polling a participant to redirect the participant focus further comprises sending a canned message to the participant.

14. The computer implemented method of claim 2, wherein tracking participant focus further comprises identifying at least one of a current page, slide, or application being viewed by the participant.

15. The computer implemented method of claim 2, wherein tracking participant focus is performed using a retinal scanner, wherein the retinal scanner monitors a participant's eyes to determine at least one of a length of time a participant focused on each slide to identify which slides received the most attention from the participant or that the participant's eyes focused on a particular area of a slide.

16. The computer implemented method of claim 15, wherein each slide in the presentation is assigned a rating based on the information obtained from the retinal scanner.

17. A data processing system for allowing participants in an online collaboration environment to control real-time presentation of collaboration materials, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to poll participants of an online collaboration for polling feedback relevant to a real-time presentation, aggregate the polling feedback to form a collective participant response in response to receiving polling feedback from the participants, dynamically modify the presentation based on the collective participant response to form a dynamically modified presentation; and provide the dynamically modified presentation to the participants.

18. A computer program product for allowing participants in an online collaboration environment to control real-time presentation of collaboration materials, the computer program product comprising:
a computer usable medium having computer usable program code tangibly embodied thereon, the computer usable program code comprising:
computer usable program code for polling participants of an online collaboration for polling feedback relevant to a real-time presentation;
computer usable program code for aggregating the polling feedback to form a collective participant response in response to receiving polling feedback from the participants;
computer usable program code for dynamically modifying the presentation based on the collective participant response to form a dynamically modified presentation; and
computer usable program code for providing the dynamically modified presentation to the participants.

19. The computer program product of claim 18, wherein polling participants of an online collaboration further comprises:
computer usable program code for tracking participant focus on a participant's computer display; and
computer usable program code for determining if the participant focus is on the presentation material currently displayed in the online collaboration.

20. The computer program product of claim 19, wherein dynamically modifying the presentation further comprises:
computer usable program code for dynamically modifying a participant polling schedule in response to determining that the participant focus is not on the presentation material currently displayed in the online collaboration.
